(19) United States
(12) Patent Application Publication
(10) Pub. No.: US 2004/0141422 A1
(43) Pub. Date: Jul. 22, 2004

(54) Perpetual lunar gauge

(76) Inventor: Alistair Fitchet, Oxford (GB)

Correspondence Address: Eric M Dobrusin, Dobrusin & Thennisch, Suite 311, 401 South Old Woodward Avenue, Birmingham, MI, 48009, US

(21) Appl. No.: 10/471,971

(22) PCT Filed: Mar. 12, 2002
(86) PCT No.: PCT/EP02/02867

(30) Foreign Application Priority Data
Mar. 14, 2001 (GB) 016228.0

(51) Int. Cl. G04B 19/26

(52) U.S. Cl. 368/18

(57) ABSTRACT

A perpetual lunar gauge consisting of a disc upon which there are arranged (49) equally spaced radial marks around the perimeter, another disc within this one around which there are arranged (32) equally spaced radial marks, and within this, another moveable disc with phases of the moon indicated upon it where a whole lunation corresponds to a concentric arc of approximately 216.96 degrees. An index arm or indicator placed upon this is used to align with any particular angle on the gauge. A central axle securing these together, allows each piece to be turned relative to the others.

This invention relates to a device for perpetually gauging the time of the moon's phases.

Devices for calculating and measuring the phases of the moon are already available. However, many of these devices are neither simple or accessible enough for provision as a general household item.

This invention provides a simple and inexpensive gauge providing an accurate correspondence with the moon's cycle and easily mountable on a wall or similar surface providing an overview of the whole lunar month each month.

According to the present invention there is provided a disc upon which there are arranged 49 equally spaced radial marks (the outer disc), another concentric disc within this one around which there are arranged 32 equally spaced radial marks (the middle disc), and within this another concentric disc with the lunar month figured upon it in some manner based upon a concentric arc whose angle corresponds to the length of time of the lunar month (lunation) where a full circle represents 49 days (the inner disc).

The angle of the arc is preferably 211 to 223 degrees, more preferably 216 to 218 degrees, more preferably still 216.96 degrees, most preferably 216.959428308 degrees.

This arc may be subdivided into angles representing each of the major phases (new moon, first quarter, full moon, last quarter, following new moon) or any other phase. Aligned on each of these phases may be markers indicating the range of oscillation that each phase can experience from one month to the next due to fluctuations in the moon's orbit. Although the moon has a mean orbital period over time it can vary around this mean from month to month and so the markers are included to cover this variation around the mean.

There may also be incorporated some form of arm or indicator used to align with any particular angle on the gauge, and the whole device may incorporate some form of hanger for wall-mounting. All these may be assembled on a central axle to secure them together and allow each piece to be turned relative to the others.

Around the outer disc there may be incorporated a further concentric disc (not shown) upon which is indicated the numbers 1 to 31 consecutively arranged according to 31 of 49 equally spaced radial marks, and/or an additional concentric disc (not shown) may be incorporated, upon which is indicated the astronomical and/or astrological zodiac corresponding to the lunar months indicated by the marks of the middle disc.

Each of the discs may move independently of the others, or the middle and outer discs may form a single movable object independently moveable from the others. There may also be means of temporarily securing one disc to another so that when secured their movement is fixed together.

Any of the parts may be moved manually, or may be moved via gearing which allows the movement of one or more parts to directly influence the movement of others in an appropriate manner, or the parts may be moved independently and automatically like a mechanical clock. Alternatively the gauge may embody a device that incorporates bars or gears that embody the ratio of the 49 divisions of the outer disc to the 32 divisions of the middle disc to the arc of lunation of the inner disc, or be virtually embodied as a computer generated or animated image.

The discs and hanger may be made of some suitable material such as card, plastic or metal. The arm may take the form of a see-through strip or a narrow pointer or similar indicator.

In order to gauge the current phases of the moon the outer and middle discs are set and fixed against one another so as to calibrate to the lunation cycle and the local time zone, with the inner disc set to the appropriate mark of the middle disc representing the current lunar month. The arm may be placed over the correct day on the outer disc corresponding to the current phase of the moon as an angle of the arc of the inner disc. Near the end of each month the inner disc is moved on to the next mark on the middle disc to correspond to the next lunation and so on, so that the gauge operates perpetually.

A specific embodiment of the invention is now described by way of example with reference to the accompanying drawings in which:

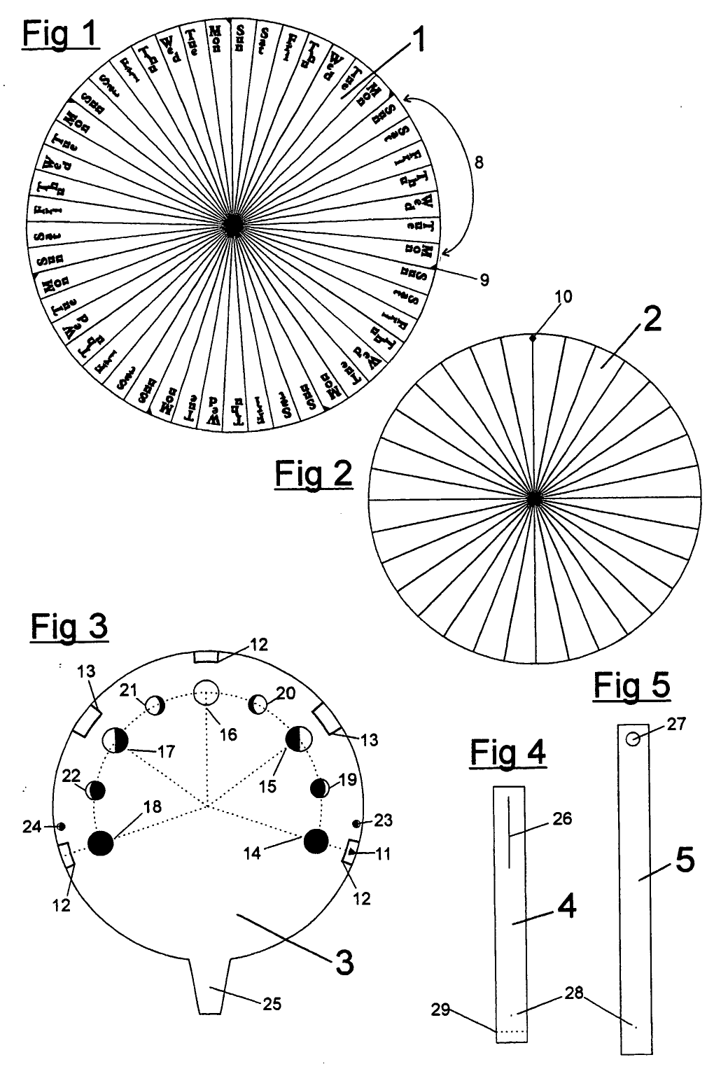

FIG. 1 shows a plan of the outer disc

FIG. 2 shows a plan of the middle disc

FIG. 3 shows a plan of the inner disc

FIG. 4 shows a plan of the arm

FIG. 5 shows a plan of the hanger

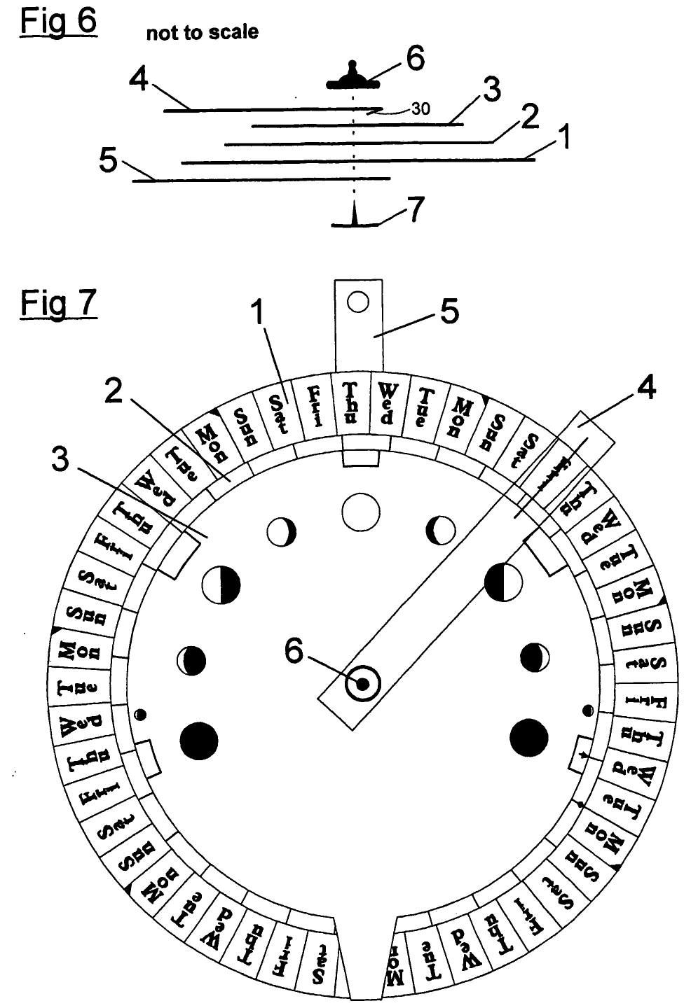

FIG. 6 shows a profile of the parts to be assembled

FIG. 7 shows a plan of the entire assembly

Referring to these drawings the gauge comprises

A disc (1) on which there are arranged forty-nine equally spaced radial marks. Between these radial lines are placed the days of the week (8) seven times in consecutive order corresponding to the forty-nine spaces between the forty-nine radial lines. At the beginning of each week there is a mark (9) to provide an indication of each of the seven consecutive weeks.

Another smaller concentric disc (2) around which are arranged thirty-two equally spaced radial marks, one of which is marked differently from the rest (10).

Another, yet smaller concentric inner disc (3) upon which are arranged icons representing the four major phases of the moon set upon a concentric arc of 216 to 218, preferably approximately 216.96 degrees of a full circle (angle marked 14 to 18). Where the arc is 216.96 degrees then starting from the beginning of the arc (14) these icons are centred on the arc at positions 0 degrees for the new moon (14), 54.24 degrees for the first quarter (15), 108.48 degrees for the full moon (16), 162.72 degrees for the last quarter (17) and 216.96 degrees for the following new moon (18). Between these are indicated the young (19) and old (22) crescent phases and waxing (20) and waning (21) gibbous phases.

At the same angles corresponding to the major phases fluctuation-ranges of nine degrees (12) and twelve degrees (13), centred on each phase-angle are indicated. Within the fluctuation-range of the first new moon is indicated an arrow (11) at exactly 0 degrees of the arc of lunation. At between 13 and 15 degrees, preferably 14.69 degrees after the start of the lunation arc is centred a mark representing the first crescent (23) and at between 13 and 15 degrees, preferably 14.69 degrees before the end of the lunation arc is centred a mark representing the final crescent (24), both of which may be accompanied by a fluctuation-range (not shown) similar to the others. The fluctuation range may be as much as 12 degrees although is generally no more than 9 degrees. A tab (25) extends out from the disc to allow it to be secured to the outer disc by means of some form of clip.

An indicator arm (4) made of see-through material upon which is marked a radial line (26). The end of the arm is folded at 29 under the main body of the arm (30) to act as a friction grip to prevent the arm from slipping.

A hanger (5) with a hole (27) for hanging upon a wall pin.

A central axle (7) such as a pin is placed centrally through discs 1, 2 and 3 and through an appropriate point (28) on the arm (4) and hanger (5). These are secured together with a suitable nut (6) fixed to the axle (7).

1. A gauge consisting of an outer disc on which there are arranged 49 equally spaced radial marks around the perimeter; another concentric middle disc around which are arranged 32 equally spaced radial marks; and another concentric inner disc (whole or pied) upon which is arranged a concentric arc whose angle corresponds to the length of time of the lunar month when a full circle represents 49 days.

2. A gauge according to claim 1, in which the concentric arc arranged on the concentric inner disc is from 211 to 223 degrees.

3. A gauge according to claim 1, in which the concentric arc arranged on the concentric inner disc is from 216 to 218 degrees.

4. A gauge according to claim 1 or claim 2, in which the concentric arc is 216.96 degrees.

5. A gauge according to any of the preceding claims, in which the concentric arc is 216.959428308 degrees.

6. A gauge as claimed in any one of the preceding claims, wherein the inner disc is movable relative to the others.

7. A gauge as claimed in any one of the preceding claims, wherein the middle disc is moveable relative to the others.

8. A gauge as claimed in any one of the preceding claims, wherein the outer disc is moveable relative to the others.

9. A gauge as claimed in any one of the preceding claims, wherein all discs are independently moveable relative to the one another.

10. A gauge as claimed in any one of the preceding claims, wherein the outer disc has arranged upon it the 7 days of the week, 7 times in consecutive order around the perimeter and corresponding to the 49 equally spaced radial marks.

11. A gauge as claimed in any one of the preceding claims, wherein the inner disc has indications of the phases of the moon figured upon it in some manner, based upon the corresponding angles of the concentric arc.

12. A gauge as claimed in any one of the preceding claims, wherein a mark is provided on the inner disc at between 13 and 16 degrees on from the start indicator to indicate the first visible crescent.

13. A gauge as claimed in any one of the preceding claims, wherein a mark is provided on the inner disc at between 13 and 16 degrees before the end of the lunation indicator is provided indicating the last visible crescent.

14. A gauge as claimed in any one of the preceding claims, containing an indicator placed upon the gauge able to align with any particular angle on the gauge.

15. A gauge as claimed in any one of the preceding claims, in which the indicator is an index arm.

16. A gauge as claimed in any one of the preceding claims, wherein an additional rotating disc is attached, upon which is indicated the numbers 1 to 31 consecutively arranged according to 31 of 49 equally spaced radial marks.

17. A gauge as claimed in any one of the preceding claims, wherein an additional rotating disc is attached, upon which is indicated the astronomical and/or astrological zodiac corresponding to the lunar months indicated by the marks of the middle disc is provided.

18. A gauge as claimed in any one of the preceding claims, wherein a tab is affixed to any one of the discs, which extends near to the edge of the outermost disc and/or any other concentric disc.

19. A gauge as claimed in any one of the preceding claims, containing a central axle used to secure components of the gauge together whilst allowing one or more of the concentric discs to be turned relative to the others.

20. A gauge as claimed in any one of the preceding claims, containing a hanger affixed to a central axle on the gauge.

21. A gauge according to any of the preceding claims, containing a fluctuation range indicator indicating 12 degrees of a full circle marked on the inner disc at one or more phases of the moon.

22. A gauge according to claim 21, in which the fluctuation ranges indicator indicates 9 degrees.

23. A gauge according to any of the preceding claims, which incorporates bars or gears that embody the ratio of the 49 divisions of the outer disc to the 32 divisions of the middle disc to the arc of lunation of the inner disc.

24. A gauge according to any of the preceding claims in which any of the parts are moved automatically by means of some drive mechanism either independently or via gearing which allows the movement of one or more parts to directly influence the movement of others.

25. A gauge according to any of the preceding claims which is virtually embodied as a computer generated or animated image.
